(19) United States
(12) Patent Application Publication
(10) Pub. No.: US 2004/0148166 A1
(43) Pub. Date: Jul. 29, 2004

(54) Noise-stripping device

(76) Inventor: Huimin Zheng, Toh Guan Road (SG)

Correspondence Address: Christine W Trebilcock, Cohen & Grigsby, 15th Floor, 11 Stanwix Street, Pittsburgh, PA, 15222, US

(21) Appl. No.: 10/481,864

(22) PCT Filed: Jun. 22, 2001
(86) PCT No.: PCT/SG01/00128

(51) Int. Cl. G10L 15/20; G10L 19/14

(52) U.S. Cl. 704/233; 704/225

(57) ABSTRACT

Improved method and device for extracting speech from noisy speech signals are described. Noise stripping algorithms carry out signal pre-processing for initial adjustment of spectral density based on the finding of maximum values between current bin and next nav number of bins, followed by identification of background noise occurring during pauses in 0.5 1 sec of speech by inter-comparing neighbouring frames to find cumulative minimum values, followed by modification of the gain vector, and determination of the noise stripped signal by multiplying the input noise-contaminated speech signal by the gain vector. When multiplying the input noise-contaminated speech signal by the gain vector, aliasing distortion is reduced using a process of time domain rotation and truncation performed on the gain vector.

### FIELD OF INVENTION

The invention relates generally to speech processing. In particular, the invention relates to a noise-stripping device for speech processing.

### BACKGROUND

The use of noise-stripping techniques for improving speech intelligibility is widely known and practiced in the field of speech processing. Typically, conventional noise-stripping techniques involve gain modification of different spectral regions of speech signals representative of articulated speech, and the degree of gain modification applied to any spectral region of speech signals depends on the signal-to-noise ratio (SNR) of that spectral region. A number of conventional noise-stripping techniques are disclosed in patents. Each of these techniques when applied to speech processing to a limited degree reduces noise in noise-contaminated speech signals, but does so usually at the expense of speech quality. The effectiveness of such techniques also lessens with increasing noise levels in the noise-contaminated speech signals.

A common problem that exists amongst the conventional noise-stripping techniques is the proper identification of speech and background noise in speech captured or recorded in a noisy environment. In such situations, speech is captured or recorded together and mixed with the background noise, therefore resulting in noise-contaminated speech signals. Since speech and background noise have not been properly identified in such noise-contaminated speech signals, the task of performing gain modification thereon for isolating uncontaminated speech signals is usually minimally successful.

A number of US patents teach or disclose noise-stripping techniques, but such teachings or disclosures have not been applied with satisfactory results. These patents include U.S. Pat. No. 4,811,404 by Vilmur et al, U.S. Pat. No. 6,001,131 by Rarnan, and U.S. Pat. Nos. 4,628,529 and 4,630,305 by Borth et al.

Vilnmur et al, incorporating Borth et al (U.S. Pat. No. 4,628,529), discloses a noise-stripping tcchnique that applies spectral subtraction, or spectral gain modification, for enhancing speech quality in which gain modification is performed on noise-contaminated speech signals by limiting gain in particular spectral regions or channels of a noise-contaminated speech signal that do not reach a specified SNR threshold. A voice metric calculator provides measurements of voice-like characteristics of a channel by measuring the SNR of the channel and using the SNR for obtaining a corresponding voice metric value from a preset table. The voice metric value is then used to determine if background noise is present in the channel by comparing such a value with a predetermined threshold value. The voice metric calculator also determines the length of time intervals between updates of background noise values relating to the channel, such information being used to determine gain factors for gain modification to the channel.

Raman discloses a technique that relies on identifying ambient noise in noise-contaminated speech signals following a predetermined duration of speech signals as a basis for noise cancellation by using a speech/noise distinguishing threshold.

Borth et al (U.S. Pat. No. 4,630,305) teaches a technique which involves splitting noise-contaminated speech signals into channels and using an automatic channel gain selector for controlling channel gain depending on the SNR of each channel. Channel gain is selected automatically from a preset gain table by reference to channel number, channel SNR, and overall background noise level of the channel.

There is therefore clearly a need for a background noise-stripping device and a corresponding method for identifying speech and background noise in noise-contaminated speech, thereafter processing the same for retrieving the speech.

### SUMMARY

In accordance with a first aspect of the invention, a method for stripping background noise component from a noise-contaminated speech signal is provided, the method comprising the steps of:

digitising the noise-contaminated speech signal to form samples grouped into frames;

dividing in the frequency domain the digitised signal into a plurality of frequency bins;

storing a plurality of frames of digitised signal equivalent to a preset length of digitised signal in a buffer;

estimating the spectrum level of a current frame of digitised signal during a preset period;

comparing the spectrum estimate of the current frame of digitised signal with a spectrum estimate representative of an earlier frame of digitised signal and selecting the lower of the two spectrum estimates during the preset period;

storing the selected lower spectrum estimate in the buffer during the preset period;

assigning the stored and selected lower spectrum estimate as representative of the current frame of digitised signal; and

setting as background noise spectrum estimate the minimum value of the stored and selected lower spectrum estimates of the plurality of frames stored in the buffer.

In accordance with a second aspect of the invention, a device for stripping background noise component from a noise-contaminated speech signal is provided, the device comprising:

means for digitising the noise-contaminated speech signal to form samples grouped into frames;

means for dividing in the frequency domain the digitised signal into a plurality of frequency bins;

means for storing a plurality of frames of digitised signal equivalent to a preset length of digitised signal in a buffer;

means for estimating the spectrum level of a current frame of digitised signal during a preset period;

means for comparing the spectrum estimate of the current frame of digitised signal with a spectrum estimate representative of an earlier frame of digitised signal and selecting the lower of the two spectrum estimates during the preset period;

means for storing the selected lower spectrum estimate in the buffer during the preset period;

means for assigning the stored and selected lower spectrum estimate as representative of the current frame of digitised signal; and

means for setting as background noise spectrum estimate the minimum value of the stored and selected lower spectrum estimates of the plurality of frames stored in the buffer.

### BRIEF DESCRIPTION OF THE DRAWINGS

Embodiments of the invention are described in detail hereafter with reference to the drawings, in which:

FIG. 1 provides a block diagram showing modules in a noise-stripping device according to a first embodiment of the invention implemented using a fixed-point processor;

FIG. 2 provides a block diagram showing modules in a noise-stripping device according to a second embodiment of the invention implemented using a floating-point processor;

FIG. 3 provides a block diagram showing calculation steps for estimation of spectrum relating to background noise;

FIG. 4 provides a block diagram showing steps performed in a gain modification process in respective modules in a gain vector modification module in the floating-point device of FIG. 2; and

FIG. 5 provides a block diagram showing a gain modification process for the fixed-point device of FIG. 1.

### DETAILED DESCRIPTION

In applying improved noise-stripping techniques involving spectral subtraction described hereinafter, noise-stripping devices according to embodiments of the invention afford the advantage of enhancing speech intelligibility in the presence of background noise. An application of such a device is in the field of enhancing speech clarity for performing automatic voice switching.

Conventional noise-stripping techniques are limited in the ability to properly identify speech and background noise components of signals representing speech contaminated with background-noise when substantially removing or reducing the background noise components from the noise-contaminated speech signals. Also, particular noise-stripping processes used in these techniques introduce artifacts and distort speech.

While conventional techniques rely on thresholds to make speech/noise decisions and/or identification of speech components for quantifying noise components following the speech components, the noise-stripping devices according to embodiments of the invention place emphasis on the identification of noise components. Most human speech patterns show that every 0.5 to 1 second of articulated speech is typically interspersed with at least one non-voice pause, during which background noise may be isolated, while most noise patterns do not show such periodic behaviour. The devices identify background noise during pauses in speech and accordingly adjust gain vectors for eliminating the background noise with minimum distortion of speech.

Algorithms are also applied in the noise-stripping devices for the characterization of background noise and for gain adjustment of background noise and speech components of a captured or recorded noise-contaminated speech signal.

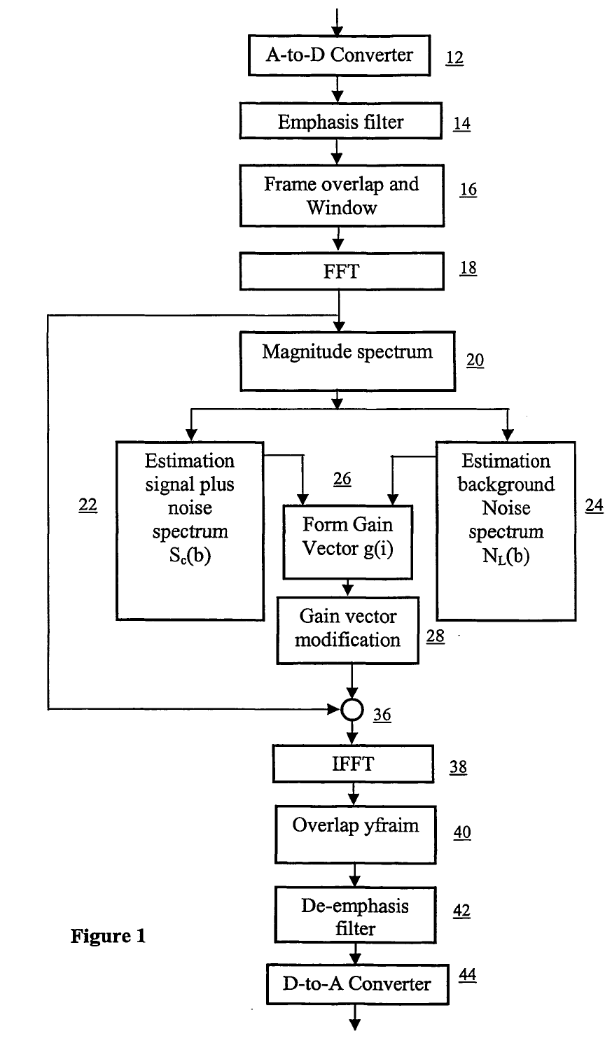

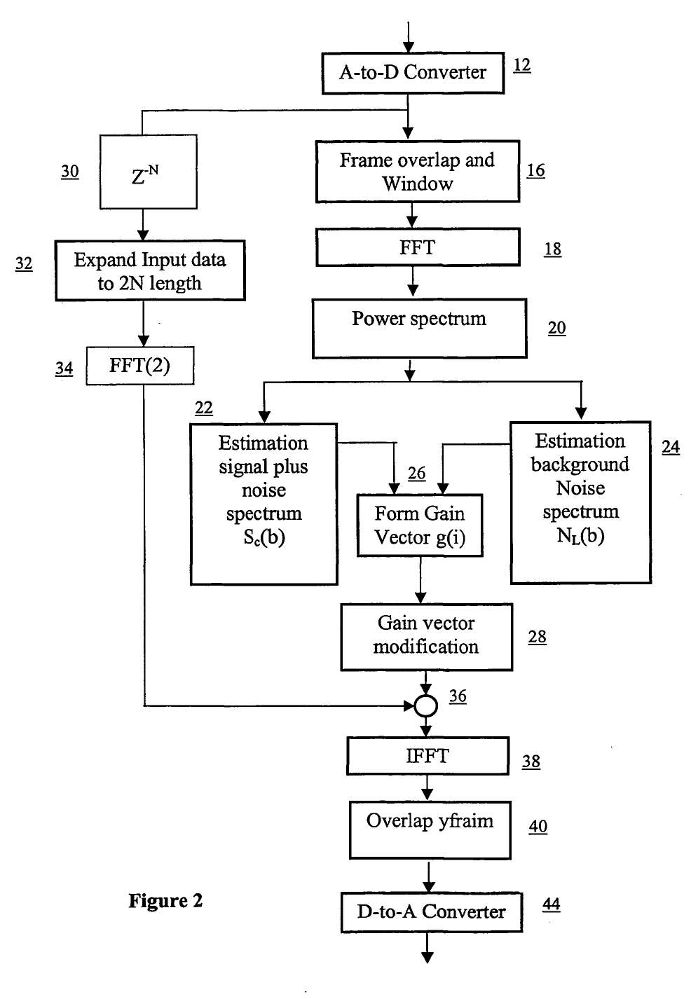

In the noise-stripping devices of which processing modules are shown in FIGS. 1 and 2, a noise-contaminated speech signal is preferably sampled and digitised at 16 kHz into samples of the noise-contaminated speech signal with 128 samples constituting a frame, so that digital signal processing may be applied. Any type of digital signal processors, combination of digital signal processing elements, or computer-aided processors or processing elements capable of processing digital signals, performing digital signal processing, or in general carrying out computations or calculations in accordance with formulas or equations, may be used in the device. Processing steps, calculations, procedures, and generally processes may be performed in modules or the like components that may be independent processing elements or parts of a processor, so that these processing elements may be implemented by way of hardware, software, firmware, or combination thereof.

The frame in the time domain is applied time-based processing and analysis by the noise-stripping devices, and converted to the frequency domain preferably using Fast Fourier Transform (FFT) techniques for frequency-based processing and analysis. Each frame in the frequency domain is divided into narrow frequency bands known as FFT bins, whereby each FFT bin is preferably set to 62.5 Hz in width. For eventual gain modification, the digitised signals are preferably processed independently in different spectral regions, of which values are preferably specified that include the bass (<1250 Hz), mid-frequency (12504000 Hz) and high-frequency (>4000 Hz) spectral regions.

The operational aspects of the noise-stripping devices are described hereinafter in greater detail with reference to FIGS. 1 and 2. During operation the noise-stripping devices digitise a noise-contaminated signal from a microphone or the like pick-up transducer and provide the digitised signal to a digital signal processor in which the background noise component is substantially removed or reduced. The speech-enhanced signal is then converted to an analog output.

Fixed- and floating-point processors are used respectively in noise-stripping devices shown in FIGS. 1 and 2, with a number of processing modules differing as shown therein. Fixed-point processors have lower power consumption and are favoured for many portable applications. However, a number of processing steps described hereinafter in relation to the floating-point implementation are not included in the fixed-point implementation due to a possibility of overflow that affects the dynamic range in the fixed-point processor in respect of FFT processing. Floating-point processors are therefore more powerfuil and provide better noise reduction and speech quality in respect of the current intents and purposes. For example, the process of windowing alone used in the fixed-point implementation reduces aliasing distortion, albeit not as effectively as the combined processes of windowing and gain vector rotation and truncation used in the floating-point implementation.

As shown in FIGS. 1 and 2, a noise-contaminated speech signal is first input to and processed by an Analog-to-Digital (A/D) Converter 12 for conversion into a digital signal consisting of frames of samples. In the fixed-point implementation in FIG. 1, the A/D Converter 12 outputs the digital signal to an Emphasis Filter 14 (of first order FIR filter) for enhancing high frequency elements of the speech component.

The Emphasis Filter 14 in the fixed-point device or the A/D Converter 12 in the floating-point device provides input to a Frame Overlap & Window module 16 in which the input consisting of two frames, i.e. a current fm and a previous fame, is overlapped and processed using a windowing function to form a windowed current block of samples consisting of 256 samples for subsequent FTT operation. The process of such a block, until the retrieval of the current frame performed in an Overlap yfraim module 40 described hereinafter, involves both the current and previous frames although the current frame remains the fine of interest during the description hereinafter. To retrieve the current frame, samples in the previous frame from the windowed current block and samples in a current frame from a windowed previous block are added to form the output of the Overlap yfraim module 40. This is possible because by applying a symmetric windowing technique in the Frame Overlap & Window module 16, in which windowed blocks are symmetrical about central points, the addition of the current and previous blocks in Overlap yfraim module 40 yields the current frame. The symmetric windowing technique is, for example, a Hang windowing technique or the preferred Hanning windowing technique.

However for purposes of simplicity and brevity, when any reference is hereinafter made to the current frame of sample until he retrieval of the current frame in the Overlap yfraim module 40, such reference is made to the current block of samples, which for all intents and purposes, includes the current frame of samples.

The output of the Frame Overlap & Window module 16 is provided as input to an FFT module 18 for conversion to the frequency domain for further processing. The current frame of samples after conversion to the frequency is defied as an output Xffts, in which the first 129 bins are used as a calculation frame in frequency domain.

The magnitude or power spectrum S relating to the current calculation frame of the input noise-contaminated speech signal, which consists of both speech and background noise components, is calculated using the first 129 bins of the frequency domain output Xffts in a spectrum calculation module 20. In this module, tie magnitude calculation operation is performed on the first 129 bins of Xffts to provide the magnitude spectrum of the current calculation frame in the fixed-point implementation in FIG. 1, and a magnitude squaring operation performed on the first 129 bins of Xffts to provide the power spectrum of the current calculation frame in the floating-point implementation in FIG. 2.

Next an estimation of the spectrum relating to the input noise-contaminated speech signal is performed in a signal-plus-noise spectrum estimation module 22. The signal-plus-noise spectrum estimation module 22 first averages the magnitude or power spectrum S over three to five calculation frames of the input noise-contaminated speech signal, then calculates the estimation of the spectrum Sc relating to the input noise-contaminated speech signal using equation (1)

$$Firstly \text{:} D ( i ) = {\sum }_{j = 1}^{k} S ( i , j ) ; k = 3 ∼ 5 , i = 0 , … N ;$$

where S is the power spectrum relating to a calculation frame of input noise-contaminated speech signal consisting of both speech and background noise components processed in the floating-point implementation in FIG. 2, or the magnitude spectrum relating to the calculation frame of noise-contaminated input signal processed in the fixed-point implementation FIG. 1; i is the FFT bin number; N is the order of a calculation frame; and D(i) is the value of S(i) averaged over k frames.

$$Then \text{:} Sc ( b ) = \frac{1}{nav} {\sum }_{i = 1}^{nav} D ( i ) ; for i = b , … , b + nav , 0 \leq b \leq N , \qquad ( 1 )$$

in which

$$nav = \{ \begin{matrix}0 for f ( b ) < 1000 Hz \\ BW / B1 for f ( b ) \geq 1000 Hz\end{matrix}$$

and D(T)=D(i),for i>N,

where:

Sc is an estimation of the spectrum relating to the input noise-contaminated speech signal;

b, i is the FFT bin number;

f(b) is the frequency of FFT bin b;

B1 is the width of the FFT bin;

and preferably

BW=150 Hz for 1000 Hz [symbol] f(b)<1500 Hz;

BW=250 Hz for 1500 Hz [symbol] f(b)<2000 Hz;

BW=350 Hz for 2000 Hz [symbol] f(b)<3000 Hz;

BW=500 Hz for 3000 Hz [symbol] f(b)<4000 Hz;

BW=1000 Hz for 4000 Hz [symbol] =f(b)<6000 Hz; and

BW=2000 Hz for 6000 Hz [symbol] =f(b)<8000 Hz.

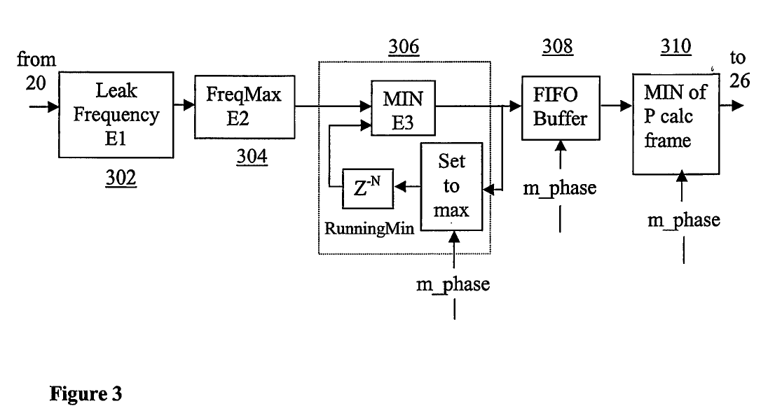

Also, an estimation of the spectrum N_{L} relating to background noise is performed in a background noise spectrum estimation module 24 by using the magnitude or power spectrum S, in which the steps for the estimation of the spectrum N_{L} relating to background noise include a number of calculation steps as represented in a block diagram shown in FIG. 3.

Firstly in a leak-frequency calculation module 302, a value Leakfrequency E1 according to known techniques is calculated from the magnitude or power spectrum S so that the frequency of each FFT bin leaks or spreads to a preset number, preferably two, of neighbouring FFT bins where E1 is the maximum magnitude or power spectrum S value within this range.

The result E1 from the leak-frequency module 302 is then used in a Freqmax calculation module 304 in which the estimation of the spectrum relating to background noise continues using equation (2), which is:

$$E2 ( b ) = {max}_{i = 1}^{nav} [ E1 ( i ) ] , for i = b , … , b + nav , 0 \leq b \leq N \qquad ( 2 )$$

in which

$$nav = \{ \begin{matrix}0 for f ( b ) < 1000 Hz \\ BW / B1 for f ( b ) \geq 1000 Hz\end{matrix}$$

and E1(N)=E1(i), for i>N;

where:

E2(b) is the output of the Freqmax module 304;

b, i is the FFT bin number;

f(b) is the frequency of FFT bin b;

B1 is the width of the FFT bin;

and preferably

BW=150 Hz for 1000 Hz [symbol] f(b)<1500 Hz;

BW=250 Hz for 1500 Hz [symbol] f(b)<2000 Hz;

BW=350 Hz for 2000 Hz [symbol] f(b)<3000 Hz;

BW=500 Hz for 3000 Hz [symbol] f)<4000 Hz;

BW=1000 Hz for 4000 Hz [symbol] =f(b)<6000 Hz; and

BW=2000 Hz for 6000 Hz [symbol] =f(b)<8000 Hz.

The next step is to find a value RunningMin in a RunningMin calculation module 306, or a local minimum value of the output of the Freqmax module 304. This is done by comparing and selecting the smaller of the output of the Freqmax module 304 obtained in the current calculation frame and the output of the Freqmax module 304 selected in the previous calculation frame, or the smaller of the output of the Freqmax module 304 obtained in the current calculation frame and the maximum value of the output of the Freqmax module 304 obtained during a reference period of m frames known as a phase clock. This maximum value is preferably limited by the bit-conversion size of the A/D Converter 12. The minimum value E3 according to equation (3) is therefore selected according to:

$$E3 ( b , j ) = \{ \begin{matrix}min [ E2 ( b , j ) , E2 ( b , j - 1 ) ] others \\ min [ E2 ( b , j ) , max value ] at phase clock\end{matrix} \qquad ( 3 )$$

The output E3 from the RunningMin module 306 is then saved to a P calculation frame length First-In-First-Out (FIFO) buffer in a FIFO Buffer store module 308 at the beginning every phase clock, in which m is preferably 16 to 32 corresponding to 128 to 256 ms of samples. During this time, the FIFO Buffer module 308 saves preferably 0.5 to 1 sec of data relating to the minimum value E3 to the P calculation frame length FIFO buffer, where P refers to the number of m calculation frames. The preferred P size is 4 so that the P frame length FIFO buffer stores up to 0.5 sec of data in the case when m=16 calculation frames, and 1 sec of data in the case when m=32.

During every phase clock or every reference period of m frames, the “best” estimate of the spectrum relating to background noise is obtained from the P calculation frame length FIFO buffer in a MIN of P Calculation Frame select module 310 using the following equation:

$${N}_{L} ( b ) = {min}_{nm = 1}^{p} [ E3 ( b , nm ) ]$$

where N_{L}(b) is the estimation of the spectrum relating to background noise as shown in FIG. 9; and um is the order of the calculation frame saved to the FIFO buffer.

After estimation of the spectrums relating to the input noise-contaminated speech signal (Sc) and the background noise (N_{L}(b)) in modules 22 and 24 respectively, a gain vector g is generated in a gain vector calculation module 26 by calculation according to the following equation:

$$g ( i ) = {\{ \frac{[ Sc ( i ) - kf * {N}_{L} ( i ) ]}{Sc ( i )} \}}^{\frac{1}{a}} , i = 0 , … , N ;$$

where kf is a constant factor preferably set between 0.5 to 2, and a=1 for fixed-point implementation in FIG. 1 and a=2 for floating-point implementation in FIG. 2. Gain modification of the input noise-contaminated speech signal in a gain vector modification module 28 using the output of the gain vector calculation module 26 involves first the modification of the gain vector g, then using the same to multiply the input noise-contaminated speech signal in the frequency domain derived from the FFT module 18 in the case of the fixed-point device shown in FIG. 1, or from an alternative FFT process in the case of the floating-point device shown in FIG. 2. Hence, different gain modification processes are appropriately implemented for the different fixed- and floating-point processors, which are described separately hereinafter. Both processes are intended to reduce artifacts and aliasing distortion in the noise-stripped speech signal.

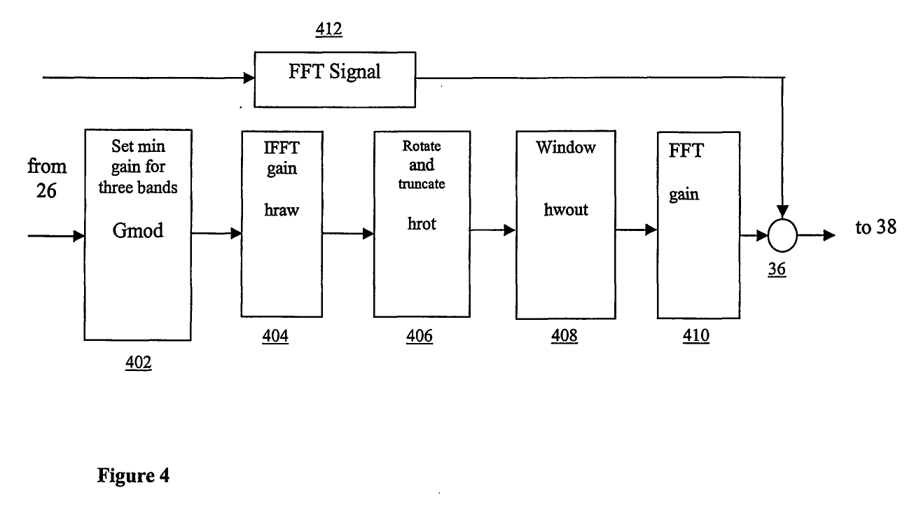

With reference to FIG. 4, the floating-point implementation in relation to the gain modification process performed in the gain vector modification module 28 for the floating-point device shown in FIG. 1 is described first. Floating-point processors have adequate dynamic range to carry out gain modification processes with very low distortion. The gain vector is transferred back to the time domain by an inverse FFT module, processed using rotating and truncating, then transferred again to the frequency domain by an FFT module. The steps performed in the gain modification process in the respective modules in the gain vector modification module 28 are shown in FIG. 4.

A Gmod module 402 is described for setting a minimum gain vector Gmod, which includes minimum gain values for the bass, mid-frequency, and high frequency spectral regions. For any minimum gain value Gbassmod, Gmidmod, or Ghighmod where the gain vector g is less than a corresponding preset minimum gain value Gbassmin, Gmidmin, or Ghighmin, the respective minimum gain value is set to the predetermined minimum gain value. Preferably, the preset value for Gbassmin is 0.15, Gmidmin is 0.2, and Ghighmin is 0.15. Otherwise, the minimum gain value follows the gain vector g accordingly:

$$Gbass mod ( i ) = \{ \begin{matrix}Gbass min , g ( i ) < Gbass min \\ g ( i ) others\end{matrix} for i = 0 , … , 20 \\ Gmid mod ( i ) = \{ \begin{matrix}Gmid min , g ( i ) < Gmid min \\ g ( i ) others\end{matrix} for i = 21 , … , 64 \\ Ghigh mod ( i ) = \{ \begin{matrix}Ghigh min , g ( i ) < Ghigh min \\ g ( i ) others\end{matrix} for i = 64 , … , 128 \\ G mod = [ Gbass mod Gmid mod Ghigh mod ]$$

An IFFT gain module 404 then performs on the minimum gain vector Gmod consisting of minimum gain values for the three spectral regions, an N+1 complex value Inverse FFT function to yield 2N real values in the time domain represented by hraw,

where hraw=IFFT[Gmod]

In a Rotate and Truncate module 406, the processes of rotation and truncation, or circular convolution, is performed on hraw by the rotating and truncating hraw, which is the minimum gain vector Gmod in the time domain, and saving the rotated and truncated hraw as hrot using

$$hrot ( i ) = \{ \begin{matrix}hraw ( i + 2 * N - N / 2 ) , i = 0 , … , N / 2 - 1 \\ hraw ( i - N / 2 ) , i = N / 2 , … , N - 1\end{matrix}$$

Next in a Window module 408, the rotated and truncated gain vector hrot is processed using a windowing technique, preferably the Hanning windowing technique, to obtain hwout via

hivout(i)=hieot(i)*w(i), i=1, . . . , N,

where w(i) is a windowing function.

After the windowing operation, an FFT Gain module 410 expands the hwout to 2N points as

$$[ \begin{matrix}hwout , & \underbrace{0 , … ,} 0\end{matrix} ] , \\ N$$

then passes on a 2N real value FFT[hwout] which is a conversion to the frequency domain.

The gain modification of the input noise-contaminated speech signal is performed through multiplication of the modified gain vector FFT[hwout] with the input noise-contaminated speech signal processed by an FFT module 412. The process performed in the FFT module 412 on the input noise-contaminated speech signal is described in greater detail with reference to FIG. 2, in which the input noise-contaminated speech signal first passes through a Z^{-N} module 30 for introducing a one-frame delay. In an Expand to 2N module 32, N samples of the delayed frame form a frame as Xin, and expands the same to 2N as

$$[ \begin{matrix}Xin , & \underbrace{0 , … ,} 0\end{matrix} ] , \\ N$$

on which an FFT(2) module 34 processes for conversion to the frequency domain as Xfft as follows:

$$Xfft = FFT [ ( \begin{matrix}Xin , & \underbrace{0 , … ,} 0\end{matrix} ) ]$$

$$N$$

where Xin is N point of input noise-contaminated speech signal.

Then, the Xfft is multiplied by the modified gain vector FFT[hwout] to produce a noise-stripped speech signal in the frequency domain in a multiplier module 36 as follows:

Y=Xfft*FFT[hwout]

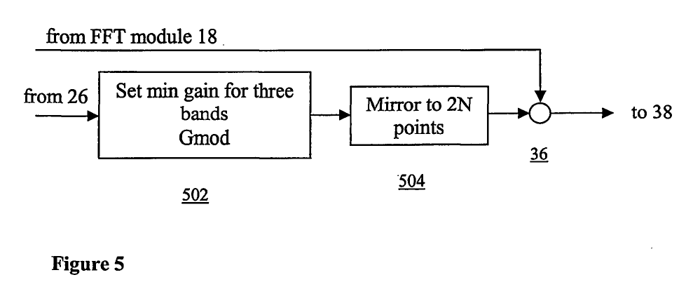

With reference to FIG. 5, the gain modification process for the fixed-point implementation is described in greater detail. The gain modification process includes modification of gain vector g and modification of the noise-contaminated input signal represented in frequency domain with the gain vector g. However, modification of the gain vector g only includes setting the minimum for the three bands, followed by mirroring the modified gain vector to 2N points.

In a Modification of gain vector module 502, the minimum gain values for the three bands are set accordingly:

$$\begin{matrix}Gbass mod ( i ) = \{ \begin{matrix}Gbass min , g ( i ) < Gbass min \\ g ( i ) others\end{matrix} & & for i = 0 , … , 20 \\ Gmid mod ( i ) = \{ \begin{matrix}Gmid min , g ( i ) < Gmid min \\ g ( i ) others\end{matrix} & & for i = 21 , … , 64 \\ Ghigh mod ( i ) = \{ \begin{matrix}Ghigh min , g ( i ) < Ghigh min \\ g ( i ) others\end{matrix} & & for i = 64 , … , 128 \\ Gmod = [ \begin{matrix}Gbassmod & Gmidmod & Ghighmod\end{matrix} ] & & \end{matrix}$$

Next in a Mirror to 2N module 504, the minimum gain vector Gmod is mirrored to 2N points as follows:

Gmod(i)=Gmod(i), for i=0, . . . ,N; Gmod(2N−i)=Gmod(i), i=1, . . . ,N−1.

The result of mirroring the minimum gain vector Gmod is then used to modify the Xffts overlapped FFT of the input noise-contaminated speech signal, in which the Xffts is multiplied with the minimum gain vector Gmod in the multiplier module 36 to produce a noise-stripped speech signal as follows:

Y=Xffts*Gmod

In an Inverse Fast Fourier Transform (IFFT) module 38, the treatment of the noise stripped speech signal for both fixed- and floating-point devices proceeds with a 2N inverse FFT to convert the noise-stripped signal to the time domain, in which:

yraw=IFFT[Y],

where Y is the noise-stripped speech signal after gain modification in frequency domain, and yraw is the speech signal stripped of the noise in time domain.

The processing then continues with the Overlap yfraim module 40, in which an overlapped noise-stripped signal is generated according to

yfraim(i,j)=yraw(i,j)+yraw(i+N,j−1), i=0, . . . ,N−1

A De-emphasis filter 42 utilized only in the fixed-point implementation then processes the overlapped noise-stripped speech signal yfraim(i,j), in which the filter is a first order IIR filter.

A Digital-to-Analog Converter 44 processes the noise-stripped speech signal for conversion back to analog domain for subsequent speech processing applications.

In the foregoing manner, noise-stripping devices according to embodiments of the invention for addressing the foregoing disadvantages of conventional noise-stripping techniques solutions are described. Although only a number of embodiments of the invention are disclosed, it will be apparent to one skilled in the art in view of this disclosure that numerous changes and/or modification can be made without departing from the scope and spirit of the invention.

1. A method for stripping background noise component from a noise-contaminated speech signal, the method comprising the steps of:
digitising the noise-contaminated speech signal to form samples grouped into frames;
dividing in the frequency domain the digitised signal into a plurality of frequency bins;
storing a plurality of frames of digitised signal equivalent to a preset length of digitised signal in a buffer;
estimating the spectrum level of a current frame of digitised signal during a preset period;
comparing the spectrum estimate of the current frame of digitised signal with a spectrum estimate representative of an earlier frame of digitised signal and selecting the lower of the two spectrum estimates during the preset period;
storing the selected lower spectrum estimate in the buffer during the preset period;
assigning the stored and selected lower spectrum estimate as representative of the current frame of digitised signal; and
setting as background noise spectrum estimate the minimum value of the stored and selected lower spectrum estimates of the plurality of frames stored in the buffer.

2. The method as in claim 1, wherein the step of storing the plurality of frames includes storing the plurality of frames of digitised signal equivalent to a preset length of at least 0.3 secs of digitised signal in the buffer.

3. The method as in claim 2, wherein the step of storing the plurality of frames includes storing the plurality of frames of digitised signal equivalent to 0.5 to 1 sec of digitised signal in the buffer.

4. The method as in claim 1, wherein the step of estimating the spectrum level includes estimating the spectrum level of the current frame of digitised signal during a preset period of 128 to 256 msecs.

5. The method as in claim 1, wherein the step of comparing the spectrum estimated includes comparing the spectrum estimate of the current fame of digitised signal with a spectrum estimate representative of an earlier adjacent frame of digitised signal.

6. The method as in claim 1, further comprising after tie dividing step and before the storing estimate step, the step of adjusting the spectrum level of the frequency divided digitised signal in relation to a frequency bin, the adjustment being dependent on neighbouring frequency bins to which the frequency is leaked.

7. The method as in claim 6, wherein the step of adjusting the spectrum level includes adjusting the spectrum level of the frequency divided digitised signal in relation to a frequency bin exceed 1 kHz.

8. The method as in claim 7, wherein the spectrum of adjusting the spectrum level includes finding the maximum specs value taken between the frequency bin and a next nav number of frequency bins according to
$$E2 ( b ) = {max}_{i = 1}^{nav} [ E1 ( i ) ] , for i = b , … , b + nav , 0 \leq b \leq N \qquad ( 2 )$$
in which
$$nav = \{ \begin{matrix}0 for f ( b ) < 1000 Hz \\ BW / B1 for f ( b ) \geq 1000 Hz\end{matrix}$$
and E1(N)=E1(i), for i>N;
whereby
E2(b) is the maximum spectrum value;
b, i is the frequency bin number,
N is the length of a frame;
f(b) is the frequency of frequency bin b;
B1 is the width of the frequency bin;
BW=150 Hz for 1000 Hz [symbol] f(b)<1500 Hz;
BW=250 Hz for 1500 Hz [symbol] f(b)<2000 Hz;
BW=350 Hz fbr 2000 Hz [symbol] f(b)<3000 Hz
BW=500 Hz for 3000 Hz [symbol] f(b)<4000 Hz;
BW=1000 Hz for 4000 Hz [symbol] f(b)<6000 Hz; and
BW=2000 Hz for 6000 Hz [symbol] f(b)<8000 Hz.

9. The method as in claim 1, further comprising the step of multiplying the noise-contaminated speech signal with a gain vector.

10. The method as in claim 9, wherein the step of multiplying the noise-contaminated speech signal with the gain vector includes:
converting the gain vector from frequency to time domain;
performing rotation and truncation operation on the gain vector; and
reforming the rotated and truncated gain vector by inserting zeros and transforming the resultant gain vector to the frequency domain.

11. The method as in claim 9, wherein the step of multiplying the noise-contaminated speech signal with the gain vector includes mirroring the gain vector.

12. The method as in claim 1, further comprising the steps of:
overlapping the plurality of frames; and
performing a windowing operation on the overlapped plurality of frames.

13. A device for stripping background noise component from a noise-contaminated speech signal, the device comprising:
means for digitising the noise-contaminated speech signal to form samples grouped into frames;
means for dividing in the frequency domain the digitised signal into a plurality of frequency bins;
means for storing a plurality of frames of digitised signal equivalent to a preset length of digitised signal in a buffer;
means for estimating the spectrum level of a current frame of digitised signal during a preset period;
means for comparing the spectrum estimate of the current frame of digitised signal with a spectrum estimate representative of an earlier frame of digitised signal and selecting the lower of the two spectrum estimates during the preset period;
means for means for storing the selected lower spectrum estimate in the buffer during the preset period;
means for assigning the stored and selected lower spectrum estimate as representative of the current frame of digitised signal; and
means for setting as background noise spectrum estimate the minimum value of the stored and selected lower spectrum estimates of the plurality of frames stored in the buffer.

14. The device as in claim 13, wherein the means for storing the plurality of frames includes means for storing the plurality of frames of digitised signal equivalent to a preset length of at least 0.3 secs of digitised signal in the buffer.

15. The device as in claim 14, wherein the means for storing the plurality of frames includes means for storing the plurality of frames of digitised signal equivalent to 0.5 to 1 sec of digitised signal in the buffer.

16. The device as in claim 13, wherein the means for estimating the spectrum level includes means for estimating the spectrum level of the current frame of digitised signal during a preset period of 128 to 256 msecs.

17. The device as in claim 13, wherein the means for comparing the spectrum estimated includes means for comparing the spectrum estimate of the current frame of digitised signal with a spectrum estimate representative of an earlier adjacent frame of digitised signal.

18. The device as in claim 13, further comprising means for adjusting the spectrum level of the frequency divided digitised signal in relation to a frequency bin, the adjustment being dependent on neighbouring frequency bins to which the frequency is leaked.

19. The device as in claim 18, wherein the means for adjusting the spectrum level includes means for adjusting the spectrum level of the frequency divided digitised signal in relation to a frequency bin exceeding 1 kHz.

20. The device as in claim 19, wherein the means for adjusting the spectrum level includes means for finding the maximum spectrum value taken between the frequency bin and a next nav number of frequency bins according to
$$E2 ( b ) = {max}_{i = 1}^{nav} [ E1 ( i ) ] , for i = b , … , b + nav , 0 \leq b \leq N \qquad ( 2 )$$
in which
$$nav = \{ \begin{matrix}0 for f ( b ) < 1000 Hz \\ BW / B1 for f ( b ) \geq 1000 Hz\end{matrix}$$
E1(N)=E1(i), for i>N;
whereby
E2(b) is the maximum spectrum value;
b, i is the frequency bin number;
N is the length of a frame;
f(b) is the frequency of frequency bin b;
B1 is the width of the frequency bin;
BW=150 Hz for 1000 Hz [symbol] f(b)<1500 Hz;
BW=250 Hz for 1500 Hz [symbol] f(b)<2000 Hz;
BW=350 Hz for 2000 Hz [symbol] f(b)<3000 Hz;
BW=500 Hz for 3000 Hz [symbol] f(b)<4000 Hz;
BW=1000 Hz for 4000 Hz [symbol] f(b)<6000 Hz; and
BW=2000 Hz for 6000 Hz [symbol] =f(b)<8000 Hz.

21. The device as in claim 13, further comprising means for multiplying the noise-contaminated speech signal with a gain vector.

22. The device as in claim 21, wherein the means for multiplying the noise-contaminated speech signal with the gain vector includes:
means for converting the gain vector from frequency to time domain;
means for performing rotation and truncation operation on the gain vector; and
means for reforming the rotated and truncated gain vector by inserting zeros and transforming the resultant gain vector to the frequency domain.

23. The device as in claim 21, wherein the means for multiplying the noise-contaminated speech signal with the gain vector includes means for mirroring the gain vector.

24. The device in claim 13, further comprising:
means for overlapping the plurality of frames; and
means for performing a windowing operation on the overlapped plurality of frames.
